(19) United States
(12) Patent Application Publication
(10) Pub. No.: US 2004/0170739 A1
(43) Pub. Date: Sep. 2, 2004

(54) Gelled juice product and method of making the same

(75) Inventors: Albert D. Bolles, Bradenton, FL (US); Beata Klamczynska, Foster City, CA (US); Cindy L. Hart, Myakka City, FL (US); Renee Mellican, Bradenton, FL (US); Kristin Parshall, Bradenton, FL (US); Jennifer DiCicco, St. Petersburg, FL (US); Richard N. McArdle, Bradenton, FL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Tropicana Products, Inc.

(21) Appl. No.: 10/376,011

(22) Filed: Feb. 27, 2003

(51) Int. Cl. A23L 1/05

(52) U.S. Cl. 426/575

(57) ABSTRACT

A gelled juice product which includes a fruit or vegetable juice and carrageenan and which is palatable, stable and can be formed into a desired shape is disclosed herein. A method of making such a gelled juice product is also disclosed.

### FIELD OF THE INVENTION

The present invention is directed to a gelled juice product and a method of making such a gelled juice product. More particularly, the present invention is directed to a gelled juice product which includes juice and carrageenan and which is palatable, stable and can be formed into a desired shape.

### BACKGROUND OF THE INVENTION

Currently, fruit and vegetable juices, such as for example orange juice, are primarily sold as a beverage. It is desirable to sell such juice in other convenient forms, such as a solid or gel. When polysaccharides are added to an aqueous solution, a three dimensional network with solvent water molecules dispersed throughout is created to form a gel. However, creation of products, which can be labeled 100% juice products, in these other convenient forms has proven to be difficult because of the chemical complexity of such juice, and in particular orange juice. Accordingly, it is an object of the present invention to provide a palatable gelled juice product which is stable at room temperature and which can be formed into shaped containers, such as tubes or cups, or into various desired shapes.

Carrageenan has been previously disclosed for juice-containing compositions. For example, U.S. Pat. No. 4,925,686 (Kastin) shows a juice-containing composition which is formulated to be freezable. The juice formulation can have up to 99 weight percent fruit juice, sugar, and citric acid, and up to 0.02 weight percent of a stabilizer. Carrageenan is listed as a possible stabilizer. This patent, however, is not directed to a gel composition. Further, the amount of carrageenan used is very low.

Carrageenan has been previously disclosed as part of a gelling agent combination. U.S. Pat. No. 3,367,783 (Billerbeck) discloses carrageenan as part of a gelling agent combination which includes locust bean gum. This patent, however, requires locust bean gum be in an amount of 50-70 percent by weight of the carrageenan-locust bean gum combination. Further, the patent requires the ingredients to be mixed at 100° F., then pumped and sealed into containers, then retorted at a high temperature for 8-10 minutes and then cooled. However, having the composition at these temperatures for such a long time and using the described process, however, negatively affects the flavor of the resulting composition.

U.S. Pat. No. 5,597,604 (Chalupa et al.) discloses what it calls a pourable gelled beverage. The beverage requires the use of gellan gum.

JP 10-10966 discloses a process for making a canned beverage having a good mouth feel, particularly with regard to fruit pulp. The process in this reference involves adding a gelling agent, such as carrageenan, to a mixture of 2 to 6 weight percent of fruit “flesh” and 30 to 50 weight percent of fruit juice, sacchrides and water. The resulting composition is heated. Before gellation occurs, the mixture is filled and hermetically sealed in a can and cooled to form a gelatinous jelly. This is followed by freezing and thawing.

The present invention is intended to overcome prior difficulties with gelled products and produce a gelled juice product which is palatable, stable and which can be formed into tubes, cups, or other desired shapes and shaped containers.

### SUMMARY OF THE INVENTION

The present invention is directed to a gelled juice product or composition and a method of making such a gelled juice product or composition.

In a preferred embodiment of the present invention, the gelled juice product includes a juice and approximately 0.28 to 0.7 weight percent of carrageenan. In a further preferred embodiment, the carrageenan is between 0.28 to 0.6 weight percent, and more preferably between 0.5 to 0.6 weight percent.

In an alternative embodiment of the present invention, the gelled juice product includes a juice and approximately 0.4 to 0.7 weight percent of a carrageenan and locust bean gum combination, wherein said locust bean gum is in an amount of approximately 0.18 or less weight percent. In a further preferred embodiment, the locust bean gum is in an amount of approximately 0.16 or less weight percent.

In a preferred embodiment, the gelled juice product of the present invention is 28 Brix or less. More preferably, the Brix is between 15-21. Brix is a measure of the percent soluble solids in a given weight of juice.

In a further embodiment of the present invention, a sweetener, citric acid, flavor and/or color can be added to the gelled juice product of the present invention.

The present invention is also directed to a method for making such a gelled juice product. In a preferred embodiment, the method comprises the steps of mixing a juice and carrageenan to form a mixture, heating the mixture to a temperature above a base gel activating temperature, decanting the heated mixture and cooling the decanted mixture to form a gelled juice product. Preferably, the heating and cooling are done as quickly as possible.

The present invention produces a highly palatable, natural tasting gelled juice product which can be labeled 100% juice and which can be solidified and remain solid at room temperature. The resulting gelled juice product does not require freezing to form or maintain its shape. The resulting gelled product can be used and is stable for a period of several months as frozen or chilled or at room temperature. The resulting gelled product can be formed into a desired shape or a shaped container such as for example a tube or cup.

The present invention is suitable for all types of fruit and vegetable juices, such as for example orange, grape, cherry, apple and carrot juice, just to name a few, or blends of such juices. Further, 100% juice can be used. The juice used to make the gelled juice product of the present invention can be not-from-concentrate juice or from concentrate juice.

### DETAILED DESCRIPTION OF THE PRESENTLY PREFERRED EMBODIMENTS

The present invention is directed to a gelled juice product or composition containing a fruit or vegetable juice and carrageenan, and a method of making such a gelled juice product.

In the preferred embodiment, the gelled juice product includes juice and approximately 0.28 to 0.7 weight percent of carrageenan. In a further preferred embodiment, the gelled juice product includes approximately 0.28 to 0.6 weight percentage of carrageenan, and more preferably, 0.5 to 0.6 weight percentage of carrageenan.

In an alternative embodiment of the present invention, a carrageenan-locust bean gum combination can be substituted for the carrageenan in the above embodiment. The carrageenan-locust bean gum combination includes locust bean gum in an amount of approximately 0.18 or less weight percent, and more preferably, 0.16 or less. The carrageenan and locust bean gum combination has a preferred ration of carrageenan to locust bean gum of from 100 to 1 to approximately 2 to 1. An example of a carrageenan-locust bean gum combination product having such a composition is sold by FMC under the name Gelcarin 654B.

The firmness and strength of the gelled juice product of the present invention can be varied by varying the type and amount of carrageenan in the gel composition. For example, if more of an iota type carrageenan is used, the gel will be softer. Alternatively, if more of a kappa type carrageenan is used, the gel will be more brittle. A combination of both types of carrageenan, such as that found in the Gelcarin 654B product, is a preferred embodiment of the present invention.

In a further embodiment, a sweetener can be added to the gelled juice product of the present invention. A number of different sweeteners can be used in the gelled juice product of the present invention, including both natural and artificial sweeteners. For example, granulated sugar, glucose, high fructose corn syrup, sucrose, sucralose, sugar alcohol, saccrine, acesulfame, aspartame and non-nuitritive high intensity sweeteners are all examples of possible sweeteners that can be used in the present invention. The amount of sweetener used varies based on the particular sweetener chosen and can vary from approximately 0.03 to 25 weight percent.

The gelled juice product of the present invention can be formed into a desired shape or formed in tubes, cups or take on the form of any rigid or semi-rigid container.

Various flavors and/or colors, which are well known to those in the art, can be added to the formula for the gelled juice product of the present invention as desired. Citrus acid could also be added as desired.

The present invention is also directed to a method for preparing the gelled juice product of the present invention. In the preferred method, the above ingredients are mixed together to form a mixture. Preferably this is done at room temperature so as to not adversely affect the taste of the final resulting gelled product. The mixture is then heated to a temperature above the gel activating temperature. The mixture is then decanted and packaged by means known in the art. The decanted mixture is then held above the gel activating temperature to pasteurize the mixture. The gel activating temperature is dependent on the type of carrageenan used. For example, for Gelcarin 654B, the mixture can be heated to approximately 190° F. (approximate 88° C.), decanted, and then held at a temperature of approximately 175° F. The decanted mixture is then cooled. Preferably, the mixture is cooled to a temperature below the gel activation temperature, such as for example below 175° F. (approximately 79° C.) for Gelcarin 654B, in order to form a gel. The heating, decanting and cooling can be done using conventional means. Preferably, the mixture is quickly heated and then cooled, so as to not adversely affect the flavor of the resulting gelled product.

The following example is being offered to illustrate but not limit the scope of the present invention.

### EXAMPLE

A gelled juice product in accordance with the present invention was formed using the following formula:

| Ingredient | Supplier/Supplier code | Lbs per 1 gallon |
|---|---|---|
| Water, filtered | | 6.077714 |
| Sugar | | 1.304329 |
| Orange juice concentrate | Tropicana | 1.723578 |
| Carrageenan | FMC, Gelcarin 654B | 0.074533 |
| Calcium Lactate, pentahydrate | Purac, PP/USP | 0.09317 |
| Asorbic Acid | | 0.009317 |
| 1% CWS Beta Carotene | | 0.005590 |
| Blend of 3 Flavors | Firmenich | 0.028409 |

The above ingredients were added to water. The resulting composition was then heated for 15 seconds to 190° F. The heated mixture was then decanted into tubes and other types of packaging. The decanted mixture was then held for approximately 1 minute at around 175° F. It was then cooled to a temperature below 175° F. in an ice bath to form a gel. The resulting gelled juice product was a palatable, natural tasting 100% juice product which remained solid at room temperature. The resulting gel product also stayed stable for months as frozen and chilled and at room temperature.

It will be understood that the embodiments and examples of the present invention, which have been described, are illustrative of some of the applications of the principles of the present invention. Numerous modifications may be made by those skilled in the art without departing from the spirit and scope of the invention.

1. A gelled juice product comprising:
a juice; and
approximately 0.28 to 0.7 weight percent of carrageenan.

2. The gelled juice product of claim 1 wherein said product comprises approximately 0.28 to 0.6 weight percent of carrageenan.

3. The gelled juice product of claim 2 wherein said product comprises approximately 0.5 to 0.6 weight percent of carrageenan.

4. The gelled juice product of claim 1 wherein said juice is fruit juice.

5. The gelled juice product of claim 4 wherein said fruit juice is selected from the group consisting of grape, cherry, apple and orange juice and blends thereof.

6. The gelled juice product of claim 1 wherein said juice is 100% orange juice.

7. The gelled juice product of claim 1 wherein said juice is not-from-concentrate juice.

8. The gelled juice product of claim 1 wherein said juice is from concentrate juice.

9. The gelled juice product of claim 1 wherein said juice is vegetable juice.

10. The gelled juice product of claim 9 wherein said juice is carrot juice.

11. The gelled juice product of claim 1 further comprising a flavor additive.

12. The gelled juice product of claim 1 further comprising a color additive.

13. The gelled juice product of claim 1 further comprising citric acid

14. The gelled juice product of claim 1 further comprising a sweetener, said sweetener selected from the group consisting of granulated sugar, glucose, high fructose corn syrup, sucrose, sucralose, sugar alcohol, saccrine, acesulfame, aspartame.

15. The gelled juice product of claim 1 wherein said gelled juice product has a Brix no greater than 28.

16. A gelled juice product comprising:
a juice; and
approximately 0.28 to 0.7 weight percent of carrageenan and locust bean gum, wherein said locust bean gum is approximately 0.18 or less weight percent.

17. The gelled juice product of claim 16 wherein said product comprises approximately 0.28 to 0.6 weight percent of carrageenan.

18. The gelled juice product of claim 17 wherein said product comprises approximately 0.5 to 0.6 weight percent of carrageenan.

19. The gelled juice product of claim 16 wherein said product comprises approximately 0.18 or less weight percent of locust bean gum.

20. The gelled juice product of claim 16 wherein said juice is fruit juice.

21. The gelled juice product of claim 20 wherein said fruit juice is selected from the group consisting of grape, cherry, apple and orange juice and blends thereof.

22. The gelled juice product of claim 16 wherein said juice is not-from-concentrate juice.

23. The gelled juice product of claim 16 wherein said juice is from concentrate juice.

24. The gelled juice product of claim 16 wherein said juice is vegetable juice.

25. The gelled juice product of claim 24 wherein said juice is carrot juice.

26. The gelled juice product of claim 16 further comprising a flavor additive.

27. The gelled juice product of claim 16 further comprising a color additive.

28. The gelled juice product of claim 16 further comprising citric acid.

29. The gelled juice product of claim 16 further comprising a sweetener, wherein sweetener is selected from the group consisting of granulated sugar, glucose, high fructose corn syrup, sucrose, sucralose, sugar alcohol, sacerine, acesulfame, aspartame.

30. The gelled juice product of claim 16 wherein said gelled juice product has a Brix no greater than 28.

31. A method for producing a gelled juice product comprising:
mixing juice and carrageenan to form a mixture;
heating said mixture to a temperature above a gel activating temperature;
decanting said heated mixture;
holding said decanted mixture at a temperature above said gel activating temperature; and
cooling said decanted mixture to form a gelled juice product.

32. The method of claim 31 wherein said heated mixture is decanted into a desired shape.

33. The method of claim 31 wherein said heated mixture is decanted into a shaped container.

34. The method of claim 31 wherein said product comprises approximately 0.28 to 0.6 weight percent of carrageenan.

35. The method of claim 31 wherein said product comprises approximately 0.5 to 0.6 weight percent of carrageenan.

36. The method of claim 31 wherein said method further comprises approximately 0.18 or less weight percent of locust bean gum.

37. The method of claim 31 wherein said juice is fruit juice.

38. The method of claim 31 wherein said fruit juice is selected from the group consisting of grape, cherry, apple and orange juice and blends thereof.

39. The method of claim 31 wherein said juice is not-from-concentrate juice.

40. The gelled juice product of claim 31 wherein said juice is from concentrate juice.

41. The method of claim 31 wherein said juice is vegetable juice.

42. The method of claim 31 wherein said juice is carrot juice.

43. The method of claim 31 further comprising a flavor additive.

44. The method of claim 31 further comprising a color additive.

45. The method of claim 31 further comprising citric acid.

46. The method of claim 31 further comprising a sweetener, wherein said sweetener is selected from the group consisting of granulated sugar, glucose, high fructose corn syrup, sucrose, sucralose, sugar alcohol, saccrine, acesulfame, aspartame.

47. The method of claim 31 wherein said gelled juice product has a Brix no greater than 28.

48. The gelled juice product of claim 15 wherein said gelled juice product has a Brix of between 15 and 21.

49. The gelled juice product of claim 30 wherein same gelled juice product has a Brix of between 15 and 21.

50. The gelled juice product of claim 47 wherein said gelled juice product has a Brix of between 15 and 21.
